(19) United States
(12) Patent Application Publication
(10) Pub. No.: US 2008/0213482 A1
(43) Pub. Date: Sep. 4, 2008

(54) Method of making a mask for sealing a glass package

(76) Inventor: Stephan Lvovich Logunov, Corning, NY (US)

Correspondence Address: CORNING INCORPORATED, SP-TI-3-1, CORNING, NY, 14831, US

(21) Appl. No.: 11/712,619

(22) Filed: Mar. 1, 2007

(51) Int. Cl. B05D 5/00

(52) U.S. Cl. 427/259; 501/15

(57) ABSTRACT

A method of making a mask for frit sealing a glass envelope comprising depositing a paste onto a glass substrate, depositing a metallic layer overtop the substrate and paste, and removing the paste and a portion of the metallic layer. The paste may be, for example, a glass frit.

### BACKGROUND OF THE INVENTION

1. Field of the Invention

This invention relates to a method for making a mask, and more particularly, a method of making a mask for frit sealing of glass substrates.

2. Technical Background

U.S. Pat. No. 6,998,776 discloses a method for frit sealing of a glass package using a radiation-absorbing glass frit. As generally described in U.S. Pat. No. 6,998,776, a glass frit is deposited in a closed line (typically in the shape of a picture frame) on a first glass substrate and heated to pre-sinter the frit. The first glass substrate is then placed overtop a second glass substrate with the frit disposed between the first and second substrates. A laser beam is subsequently traversed over the frit (typically through one or both of the substrates) to heat and melt the frit, creating a hermetic seal between the substrates.

One use for such a glass package is in the manufacture of organic light emitting diode (OLED) display devices. An exemplary OLED display device comprises a first glass substrate on which is deposited a first electrode material, one or more layers of organic electroluminescent material, and a second electrode. At least one of the electrode layers is usually transparent to depending upon whether the display device is a top emitting device, a bottom emitting device, or both.

One characteristic of the organic electroluminescent material is its low damage threshold with respect to heat. That is, the temperature of the electroluminescent material must generally be maintained below about 100° C. to avoid degradation of the material, and subsequent failure of the display device. Thus, the sealing operation must be performed in a manner which avoids heating of the electroluminescent material.

A typical scenario for heating laser heating of the frit includes the use of a laser beam (or other light source capable of heating the frit to its melting temperature) which is at least as wide as the line of frit deposited on the first substrate, which may be in excess of 1 mm. As the frit is generally not deposited a substantial distance from the electroluminescent material, care must be taken so as not to inadvertently contact the electroluminescent with the laser beam. To facilitate heating of the frit while at the same time avoiding undue heating of the electroluminescent material, a mask is sometimes used to ensure the laser beam does not stray from the frit. The mask is placed over the two substrates having the frit sandwiched between them, and the mask (and frit) irradiated with the beam. Light from the laser (or other source) which is incident on the mask is absorbed by the mask, or preferably reflected away (as heating of the mask can be detrimental to the lifetime of the mask).

As the size of display substrates increase in size, to in excess of several square meters, the ability to produce masks with the requisite accuracy to prevent inadvertent heating of the electroluminescent material has become challenging. This is particularly important since much of the value of the display is inherent in the deposited electroluminescent materials and other supporting structures (e.g. electrodes) within the device, and error during the frit sealing process has large financial consequences.

### SUMMARY

In accordance with an embodiment of the present invention, a method of making a mask for sealing a glass package is described comprising providing a transparent substrate, depositing a paste onto the substrate, depositing a metallic layer overtop the substrate and the paste; and, removing the paste and a portion of the metallic layer to form a mask on the transparent substrate.

In another embodiment, a method of making a mask for sealing a glass package is disclosed comprising providing a transparent glass substrate, depositing a line of frit onto the substrate, depositing a metallic layer overtop the substrate and the frit, and removing the frit and a portion of the metallic layer to form a mask on the transparent substrate.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate an exemplary embodiment of the invention and, together with the description, serve to explain the principles and operations of the invention.

### BRIEF DESCRIPTION OF THE DRAWINGS

FIG. 1 is a downward-looking perspective view of a portion of a mask assembly made according to an embodiment of the present invention, comprising a substrate and a line of paste in the shape of a frame.

FIGS. 2A-2D are cross sectional views of various stages of making a mask assembly, beginning with depositing a line of paste in 2A, depositing a metallic layer or layers overtop the substrate and paste line in 2B, and the finished mask after removal of a portion of the metallic layer and the paste line in 2C. FIG. 2D illustrates a multilayer metal layer.

FIG. 3 is a downward-looking perspective view of a mask assembly made according to an embodiment of the present invention, comprising a substrate and a plurality of frame-shaped exposed areas.

FIG. 4 is a top view of a mask made in accordance with an embodiment of the present invention being used for the sealing of an OLED display device.

### DETAILED DESCRIPTION

In the following detailed description, for purposes of explanation and not limitation, example embodiments disclosing specific details are set forth to provide a thorough understanding of the present invention. However, it will be apparent to one having ordinary skill in the art, having had the benefit of the present disclosure, that the present invention may be practiced in other embodiments that depart from the specific details disclosed herein. Moreover, descriptions of well-known devices, methods and materials may be omitted so as not to obscure the description of the present invention. Finally, wherever applicable, like reference numerals refer to like elements.

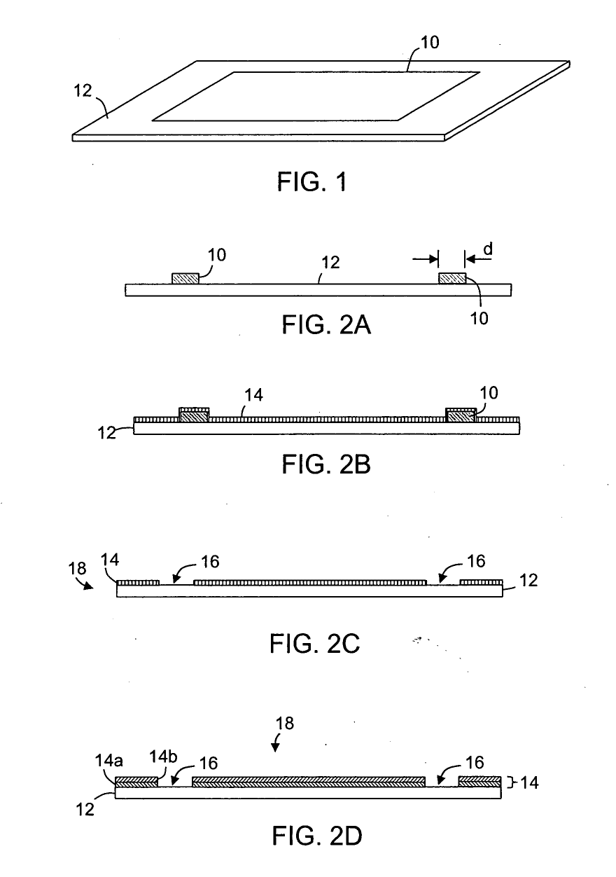

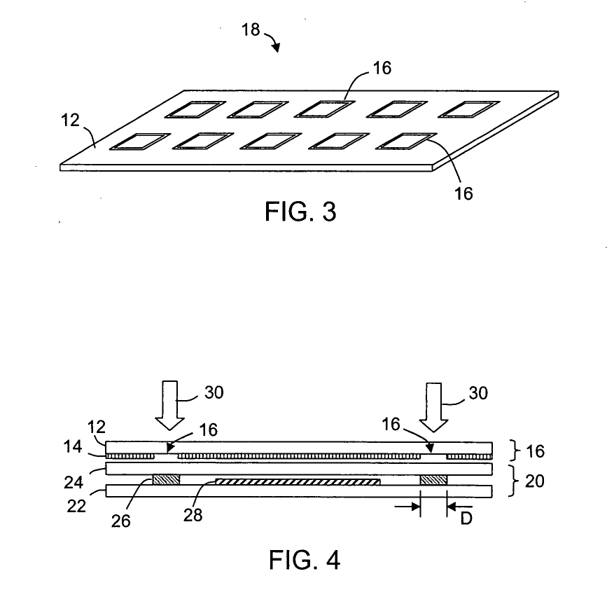

In accordance with the present invention, and as illustrated in FIGS. 1-2, a method of making a mask for use in sealing a glass package with frit is contemplated comprising first depositing a line 10 of paste onto a substantially transparent substrate 12 (e.g. a transmittance of at least about 90%). Preferably, the paste is a glass frit, but in some embodiments may be a polymer paste. The paste line 10 is generally in the shape of a picture frame, in that the line closes on itself to form a contiguous circuit. Paste line 10 is generally rectangular in shape, but may be other shapes, and in any event conforms to the shape of the frit of the glass package to be sealed. Preferably width “d” of the paste line is less than the width “D” (see FIG. 3) of the frit to be sealed. A cross sectional view of paste line 10 deposited on substrate 12 is shown in FIG. 2A.

The paste may be deposited onto the substrate by any one of several methods. For example, the paste may be deposited by extruding the paste from a nozzle or hollow needle, by screen printing, or by any other dispensing methods known in the art. It is preferred, however, that the paste be deposited in the same manner as the frit for substrate sealing is deposited, as this ensures that the paste conforms to the geometry of the later sealing frit line.

If the paste to be used for the manufacture of the mask is a glass frit, the glass frit may be heated after being deposited in order to dry the frit (e.g. drive off the volatile vehicle). The frit comprises primarily various glass powders, a binder and—usually—a solvent vehicle. By removing the volatile vehicle, a cleaner mask line (transparent opening in the mask) can be made. As the frit will be later removed, it is desirable not to heat the frit sufficiently to sinter the frit. For example, the frit may be heated to a temperature of about 50° C. but below 300° C. for a period of time of greater than about 15 minutes (e.g. 15-20 minutes. However, the frit need not be actively heated, and open air drying at room temperature for 15-20 min is an acceptable alternative.

If the paste is instead a polymer material, such as any one of a wide range of acrylic polymers, the polymer may be cured after the step of depositing the paste according to the curing instructions for the particular polymer selected.

Once the paste has been deposited and, if appropriate, treated (curing in the case of a polymer paste), the substrate comprising paste line 10 is coated with a metallic layer 14, illustrated in FIG. 2B. The metallic layer may be selected from such metals as aluminum, copper, silver or gold for example. Preferably the metallic layer is reflective at the particular wavelength of the radiation used to heat the sealing frit during the subsequent package sealing process.

Metallic layer 14 may be deposited by any convention deposition method, including, for example, vapor deposition or sputtering. It has been found that a more uniform deposition of the metallic layer can be accomplished if the substrate-paste assembly is stationary during the metallic layer deposition process. Once the metallic layer has been deposited, the paste, and the portion of the metallic layer deposited overtop the paste, is removed by washing the substrate. For example, substrate 12 may be washed in a solvent, such as acetone, and gently wiped to remove the paste and a portion of the metallic layer deposited overtop the paste. Other methods of removing the paste, and the portion of the metallic layer overtop the paste, may be used as appropriate. In some embodiments, a pressure spray may be used to remove the paste and the metallic layer overtop the paste. In the case of a polymer, heating of the substrate, including the polymer and metallic layer may be necessary to facilitate removal of the polymer. As polymers vary widely, the heating applied to assist in the polymer removal can also vary, and can be determined easily and without undue experimentation by those skilled in the art. Removal of paste 10 and the portion of the metallic layer over the paste exposes a portion 16 of the substrate in the shape of the removed paste, as depicted in FIG. 2C.

In some instances it may be necessary to use a multilayer metallic layer 14, wherein metallic layer 14 may itself comprise one or more layers shown as layer 14a and layer 14b in FIG. 2D. For example, the metallic layer may comprise a layer of aluminum (Al) and a layer of copper (Cu). The aluminum layer may be used, for example, to serve as an adhesion layer between the copper and the substrate. Other metals may be used depending on the characteristics of the particular sealing radiation, as different sealing frits may have different absorption characteristics.

Finished mask 18 may be further cleaned as required, and used in a frit sealing process to produce a glass package, such as the glass package earlier described in the manufacture of an OLED display device. The mask may, in some embodiments, serve a secondary function as a weight to ensuring a substantially uniform downward force on the glass package. A uniform sealing pressure assists in obtaining a hermetic seal for the package. In some embodiments, metallic layer 14 may be coated with a thin layer of transparent SiO to prevent oxidation of the metallic layer. Oxidation of the metallic layer may lead to undue absorption by the mask of the radiation used to seal the glass package, and cause overheating of the mask. This overheating may ultimately lead to degradation of the mask.

In some embodiments, shown in FIG. 3, mask 18 may comprise a plurality of exposed areas 16 for sealing a plurality of glass packages in rapid succession, or simultaneously, depending on the sealing techniques used. This may prove advantageous to throughput in a large scale production environment.

FIG. 4 is a cross sectional view illustrating mask 18 having a single exposed region made in accordance with the present invention in an exemplary use in the sealing of an assembly 20 for the manufacture of an OLED display device. Mask 18 is placed over glass assembly 20 to be sealed, wherein glass assembly 20 comprises first substrate 22, second substrate 24, frit line 26 and, in the present embodiment, electroluminescent layer 28. Exposed portion 16 of mask 18 is aligned to coincide with frit line 26 of assembly 20, and mask 18 is irradiated with a suitable radiation, indicated by arrows 30, to perform the sealing. In some embodiments, the radiation 30 may be a laser beam having a wavelength which will be absorbed by frit 26. For example, the laser beam may be traversed over exposed portion 16 to irradiate and heat frit 26. In other embodiments, the radiation may emanate from a broadband infrared source and irradiate all or a substantial portion of the mask simultaneously. Preferably, mask 18 is oriented such that the metallic layer is adjacent assembly 20 (i.e. second substrate 24), as this provides better control over the spread of the radiation onto frit 26. However, in the instance where a multilayer metallic layer is used, and the first, Al layer is applied directly to substrate 12, reversing the orientation of substrate 12 such that the radiation is first incident on the second metallic layer on top of the Al may be warranted if the second metallic layer is more reflective than the Al layer. Typically, a thin Al layer is needed for improved adhesion of the metal layers to glass. However, this reversed orientation results in a broader widthwise spread of the radiation on frit 26. The appropriate source and the manner of irradiating the mask will depend upon the frit composition to be heated and melted, and the application of the sealing process (e.g. whether or not heat sensitive organic materials are used in the manufacture of the glass package). The radiation is reflected and/or absorbed at the metallic layer portions of the mask, and transmitted through exposed portions 16 of the substrate not covered by the metallic layer, thus heating and melting frit 26 and sealing first and second substrates 22, 24 one to the other to form an hermetically sealed glass package (e.g. an OLED display device).

It should be emphasized that the above-described embodiments of the present invention, particularly any “preferred” embodiments, are merely possible examples of implementations, merely set forth for a clear understanding of the principles of the invention. Many variations and modifications may be made to the above-described embodiments of the invention without departing substantially from the spirit and principles of the invention. All such modifications and variations are intended to be included herein within the scope of this disclosure and the present invention and protected by the following claims.

What is claimed is:

1. A method of making mask for sealing a glass package comprising:
providing a transparent substrate;
depositing a paste onto the substrate;
depositing a metallic layer overtop the substrate and the paste; and
removing the paste and a portion of the metallic layer to form a mask.

2. The method according to claim 1 wherein the paste is a glass frit.

3. The method according to claim 1 wherein the paste is a polymer.

4. The method according to claim 1 wherein the paste is a line that closes on itself to form a frame shape.

5. The method according to claim 1 wherein the depositing the paste comprises extruding the paste from a nozzle.

6. The method according to claim 1 wherein the depositing the paste comprises screen printing.

7. The method according to claim 2 further comprising drying the glass frit prior to depositing the metallic layer.

8. The method according to claim 7 wherein the heating comprises drying the glass frit at a temperature greater than about 50° C. but less than 300° C. for at least about 15 minutes.

9. The method according to claim 1 wherein the metallic layer comprises a metal selected from the group consisting of aluminum, silver, copper, gold, and combinations thereof.

10. The method according to claim 1 wherein the metallic layer comprises a plurality of layers.

11. The method according to claim 1 wherein the metallic layer is deposited by sputtering.

12. The method according to claim 1 further comprising using the mask of claim 1 to seal a glass package.

13. A method of making a mask for sealing a glass envelope comprising:
providing a transparent glass substrate;
depositing a line of frit onto the substrate;
depositing a metallic layer overtop the substrate and the frit; and
removing the frit and a portion of the metallic layer to form a mask on the transparent substrate.

14. The method according to claim 13 wherein depositing a line of frit comprises depositing a plurality of frit lines.

15. The method according to claim 13 wherein the line of frit forms closes on itself to form a continuous circuit.

16. The method according to claim 13 further comprising coating the metallic layer with SiO.

17. The method according to claim 13 wherein the metallic layer comprises a layer comprising Al and a layer comprising Cu.

18. The method according to claim 13 wherein the depositing a metallic layer comprises depositing a first layer of Al on the glass substrate and depositing a second layer of Cu over the Al layer.

19. A mask for frit sealing a glass package made by the method of claim 13.
